(19) United States
(12) Patent Application Publication
(10) Pub. No.: US 2011/0020016 A1
(43) Pub. Date: Jan. 27, 2011

(54) IMAGE FORMING APPARATUS

(75) Inventor: Kousuke Takahashi, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/842,841

(22) Filed: Jul. 23, 2010

Related U.S. Application Data
(60) Provisional application No. 61/228,826, filed on Jul. 27, 2009.

(51) Int. Cl. G03G 15/20

(52) U.S. Cl. 399/21; 399/322; 399/67

(57) ABSTRACT

According to the embodiment, an image forming apparatus includes a paper transporting unit configured to transport a paper, an image forming unit configured to form an image on the paper, a fixing unit configured to generate heat for fixing the image on the paper, and a lighting unit configured to irradiate the fixing unit with red light.

### CROSS-REFERENCE TO RELATED APPLICATION

This application is based upon and claims the benefit of priority from: U.S. provisional application 61/228,826, filed on Jul. 27, 2009, the entire contents of each of which are incorporated herein by reference.

### FIELD

Embodiments described herein relate generally to an image forming apparatus provided with a lighting unit configured to light a fixing unit.

### BACKGROUND

In the interior of the image forming apparatus, there is a portion which is heated to high temperatures through its use. Therefore, an alert is given to a user who is about to touch the interior of the image forming apparatus by sticking a label at the portion which might be heated to high temperatures. However, the label as described above may be insufficient as the alert to the user.

### BRIEF DESCRIPTION OF THE DRAWINGS

FIG. 1 is a drawing showing an interior structure of an image forming apparatus according to a first embodiment;

FIG. 2 is a drawing showing a state in which a cover of the image forming apparatus is opened to expose a fixing unit;

FIG. 3 is an appearance view of the fixing unit according to the first embodiment;

FIG. 4 is a cross-sectional view taken along the line A-A in FIG. 3;

FIG. 5 is a cross-sectional view taken along the line A-A in FIG. 3, showing a state of occurrence of a paper jam;

FIG. 6 is a drawing corresponding to FIG. 5, showing a state in which the cover is opened;

FIG. 7 is an appearance view of a lighting unit;

FIG. 8 is a drawing showing a lighting area of the lighting unit;

FIG. 9 is a block diagram showing a circuit configuration which drives the lighting unit;

FIG. 10 is a drawing showing a state in which a relay unit is opened;

FIG. 11 is a drawing showing a state in which a plurality of lighting elements illuminate the fixing unit;

### DETAILED DESCRIPTION

According to the embodiment, the image forming apparatus includes a paper transporting unit configured to transport a paper, an image forming unit configured to form an image on the paper, a fixing unit configured to generate heat for fixing the image on the paper, and a lighting unit configured to illuminate a red light on the fixing unit.

### First Embodiment

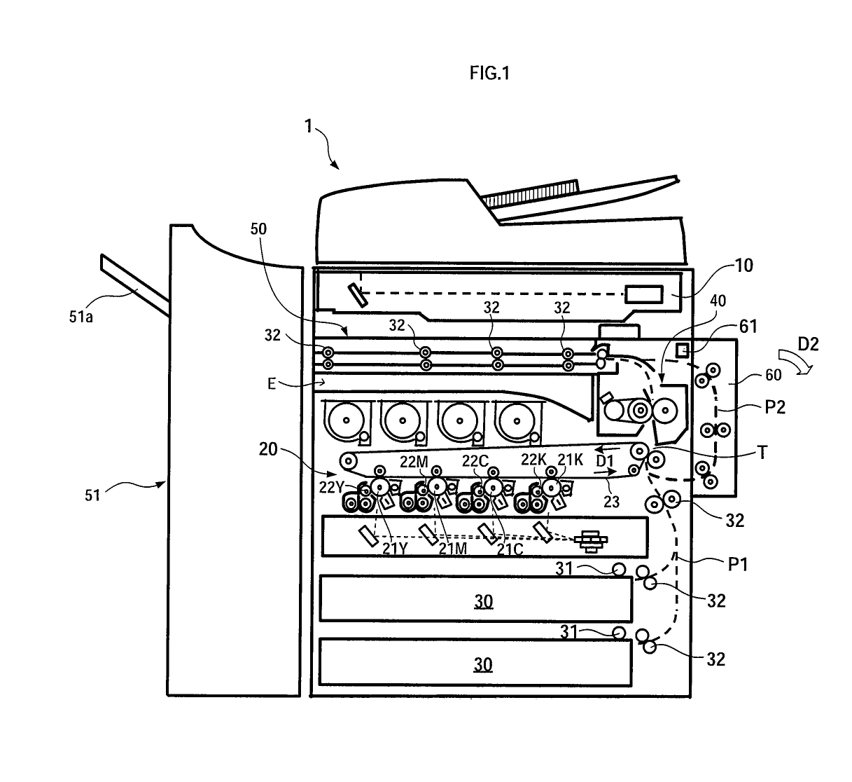

First of all, the image forming apparatus of this embodiment will be described with reference to FIG. 1. As shown in FIG. 1, an image forming apparatus 1 includes an image scanning unit 10 and an image forming unit 20.

The image scanning unit 10 has a function to scan and read images on paper documents and documents in the form of a book. The image forming unit 20 has a function to form a toner image on the paper on the basis of image data generated by a scanning action of the image scanning unit 10 or image data or the like transmitted from external apparatuses (for example, personal computers) to the image forming apparatus 1.

As an example of a process performed by the image forming apparatus 1 in this embodiment, an outline of a copying will be described.

First of all, a pickup roller 31 picks up a paper in a paper feeding cassette 30, and the picked-up paper moves along a transporting passage P1. The transporting passage P1 includes a plurality of rollers (part of the paper transporting unit) 32, and the paper moves with the rotations of the plurality of rollers 32.

Subsequently, the image forming unit 20 forms an electrostatic latent image on a photoconductive surfaces of photoconductive members 21Y, 21M, 21C, and 21K on the basis of the image data generated by the scanning action of the image scanning unit 10. The photoconductive members 21Y to 21K are used for transferring toner images in yellow (Y), magenta (M), cyan (C), and black (K) onto the paper.

Subsequently, developing rollers (so-called magnetic rollers) 22Y, 22M, 22C, and 22K supply toner to the photoconductive members 21Y to 21K on which the electrostatic latent images are formed, thereby making the electrostatic latent images formed on the photoconductive surfaces of the photoconductive members 21Y to 21K visible. The photoconductive members 21Y to 21K transfer the toner images formed on the photoconductive surfaces thereof to an intermediate transfer belt 23 (so-called “primary transfer”). The intermediate transfer belt 23 transports the toner images by the rotation in the direction indicated by an arrow D1, and transfers the toner images on the intermediate transfer belt 23 onto the paper at a secondary transfer position T.

The paper on which the toner images are transferred moves to a fixing unit (fixing unit) 40, and the fixing unit 40 heats the paper to fix the toner images to the paper. The paper having the fixed toner images moves through the transporting passage P1 with the rotation of the plurality of rollers, and then moves to a relay unit 50.

The relay unit 50 is located below the image scanning unit 10. The relay unit 50 transports the paper from the fixing unit 40 to a finisher 51. The relay unit 50 includes the plurality of rollers 32, and the rollers 32 move the paper. A space E exists below the relay unit 50. The paper moved to the finisher 51 is stacked on a tray 51a.

On the other hand, the image forming apparatus 1 includes a cover 60, and the cover 60 constitutes a part of an exterior of the image forming apparatus 1. In this embodiment, the cover 60 is provided on a side surface of the image forming apparatus 1, and constitutes a part of a transporting passage P2 for the paper. The transporting passage P2 is a passage for inverting the paper.

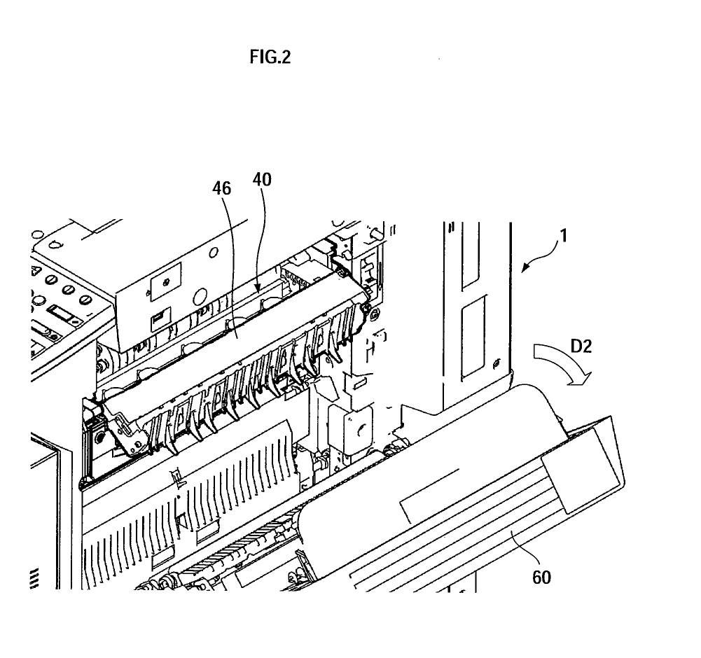

The cover 60 is rotatable from a position shown in FIG. 1 (closed position) in the direction indicated by an arrow D2, and can be moved to an opened position. The movement of the cover 60 to the opened position exposes the interior of the image forming apparatus 1. In this embodiment, as shown in FIG. 2, the fixing unit 40 becomes visible from the outside of the image forming apparatus 1 by opening the cover 60. In this embodiment, the structure in which the cover 60 rotates is employed. However a structure in which the cover 60 slides is also conceivable.

The image forming apparatus 1 includes a sensor 61 used for sensing whether the cover 60 is opened or closed. If the cover 60 moves from the closed position shown in FIG. 1 toward the opened position, it brings about change in an output signal from the sensor 61. A monitoring of the output signals from the sensor 61 enables determination of the position of the cover 60. What is essential for the sensor 61 is just to be capable of sensing whether the cover 60 is opened or closed, and hence a mechanical switch or an optical sensor is also conceivable. The detailed structure of the sensor 61 is known in public. Therefore, detailed description will be omitted.

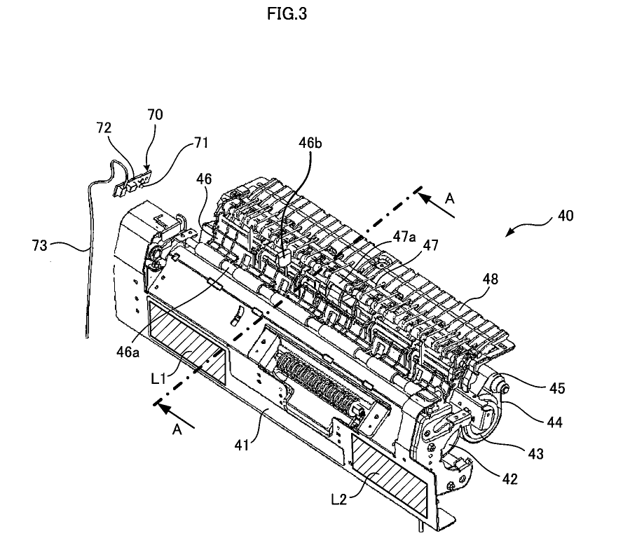

Subsequently, the fixing unit 40 will be described with reference to FIG. 3. FIG. 3 is an appearance drawing showing the fixing unit 40, and observation of the fixing unit 40 from the outside of the image forming apparatus 1 is enabled when the cover 60 is opened.

The surface of a frame 41 includes a warning label L1 and a guidance label L2 stuck thereon. The warning label L1 indicates a warning for alerting the user that it may be hot. The warning that the warning label L1 indicates may be a sentence or may be a sign or the like. The user can recognize that the portion having the warning label L1 stuck thereon may be hot by seeing the warning label L1.

The guidance label L2 indicates a procedure of a jam removal operation to be performed if a paper jam occurs in the fixing unit 40. The user is capable of understanding the procedure of the jam removal operation by seeing the contents indicated on the guidance label L2. In this embodiment, the frame 41 includes the warning label L1 and the guidance label L2 stuck thereon. However, it is possible to omit at least one of the warning label L1 and the guidance label L2.

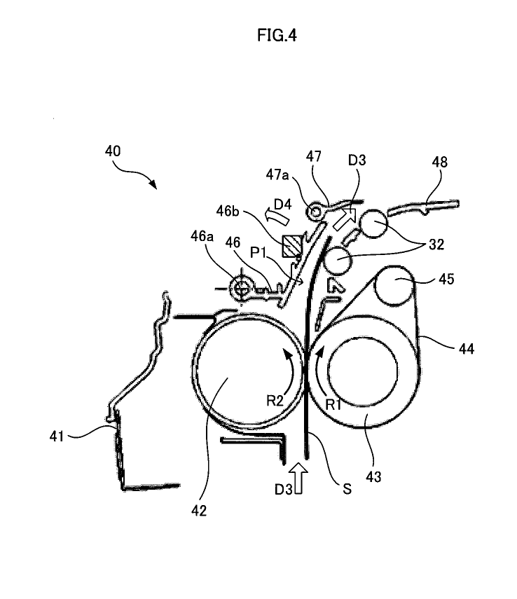

FIG. 4 is a cross-sectional view taken along the line A-A in FIG. 3. The fixing unit 40 fixes the toner images on the paper by heating and, simultaneously, transporting the paper by a press roller 42 and a heating belt 44. The heating belt 44 is wound around a fixing roller 43 and a heating roller 45 so as to extend therebetween, and the heating roller (part of a heating apparatus) 45 heats the heating belt (part of the heating apparatus) 44. The heating belt 44 moves in the direction indicated by an arrow R1, and the press roller 42 rotates in the direction indicated by an arrow R2.

In this embodiment, the paper is heated using the heating belt 44. However, it is also possible to arrange a hater in the interior of the roller which comes into contact with the press roller 42 and heat the paper.

As shown in FIG. 4, a paper S moves in the direction indicated by an arrow D3 by the rotations of the press roller 42 and the heating belt 44. In other words, the paper S moves along the transporting passage P1.

A guiding member 48 is provided above the fixing roller 43 and the heating roller 45, and the guiding member 48 constitutes a part of the transporting passage P1. The paper moves along the guiding member 48 with the rotation of the rollers 32 arranged along the guiding member 48.

A cover 46 is provided at a position opposing the guiding member 48 and the rollers 32. The cover 46 can be rotated about a rotating shaft 46a, and the frame 41 supports the cover 46. The rotating shaft 46a extends in the direction orthogonal to the paper plane of FIG. 4, and is substantially parallel to rotating shafts of the press roller 42 and the fixing roller 43.

One of surfaces of the cover 46 constitutes a part of the transporting passage P1, and the other surface includes a handle 46b. If the user pulls the handle 46b, the cover 46 rotates in the direction indicated by an arrow D4.

The cover 46 includes a claw member 47 at a distal end portion thereof, and the cover 46 and the claw member 47 are connected to each other. The claw member 47 is rotatable with respect to the cover 46 about a rotating shaft 47a. The rotating shaft 47a extends in the direction orthogonal to the paper plane of FIG. 4, and is substantially parallel to the rotating shafts of the press roller 42 and the fixing roller 43.

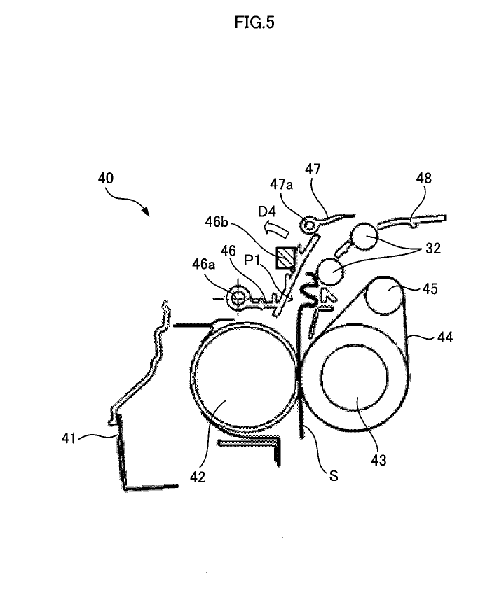

FIG. 5 shows a state in which a jam of the paper S occurs in the fixing unit 40. In the example shown in FIG. 5, the jam of the paper S occurs in the vicinity of the rollers 32. If the jam occurs, it is necessary to remove the paper S.

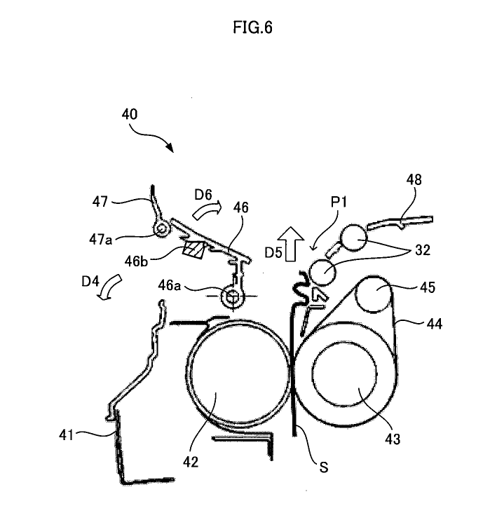

In this embodiment, if the user pulls the handle 46b of the cover 46, the cover 46 rotates in the direction indicated by the arrow D4. Then, the cover 46 assumes the state shown in FIG. 6. As shown in FIG. 6, widening a distance between the cover 46 and the guiding member 48 allows the user to remove the jammed paper S easily from the fixing unit 40. In the example shown in FIG. 6, the paper S may be pulled in the direction indicated by an arrow D5. If the user rotates the cover 46 further from the position shown in FIG. 6 in the direction indicated by the arrow D4, the state shown in FIG. 2 is assumed.

After the removal of the jammed paper S, the state shown in FIG. 4 can be restored by the rotation of the cover 46 in the direction indicated by an arrow D6 in FIG. 6.

Subsequently, a lighting unit (lighting unit) 70 configured to illuminate the fixing unit 40 will be described. As shown in FIG. 3, the lighting unit 70 is provided on the side of one end of the fixing unit 40 (the press roller 42 and the fixing roller 43) in the longitudinal direction. The lighting unit 70 irradiates the fixing unit 40 with illuminating light. The illuminating light used here is red light. The red light is light which reaches its peak in a range not less than 600 nm in wavelength of an emission spectrum, and generally is light having a wavelength within the range from 610 to 750 nm.

The lighting unit 70 is fixed to a main body of the image forming apparatus 1. The lighting unit 70 includes lighting elements 71 and a substrate 72 configured to support the lighting elements 71. The lighting unit 70 receives drive signals from a controller via a cable 73. Upon receipt of the driving signals by the lighting unit 70, the lighting elements 71 emit lights, and the illuminating lights therefrom reach the fixing unit 40.

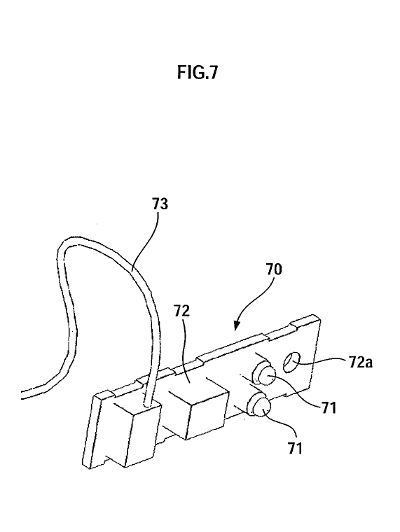

The substrate 72 is inclined with respect to a horizontal plane so that the illuminating lights from the lighting elements 71 reach the fixing unit 40. As shown in FIG. 7, the substrate 72 includes an opening 72a, and the opening 72a is used for fixing the substrate 72 to the main body of the image forming apparatus 1.

As shown in FIG. 7, the number of the lighting elements 71 used in this embodiment is two. More specifically, the two lighting elements 71 are aligned in the vertical direction (the vertical direction in FIG. 1) of the image forming apparatus 1. Optical axes of the illuminating lights of the two lighting elements 71 are substantially parallel to each other.

The respective lighting elements 71 illuminate the entire fixing unit 40. More specifically, the entire part of the cover 46 (including the claw member 47) can be irradiated with the illuminating lights from the lighting elements 71. If the cover 46 is at the opened position (the positions shown in FIG. 2 and FIG. 5), the nip between the press roller 42 and the heating belt 44 (fixing roller 43) is allowed to be irradiated with the lights from the lighting elements 71. For example, as shown in FIG. 8, the illuminating lights can be introduced into a lighting area IR including a nip NP. The surface area of the lighting area IR can be set as needed.

As the lighting elements 71, for example, LEDs (Light Emitting Diodes) are conceivable. The number of the lighting elements 71 may be one or more than two. In this embodiment, the lighting areas of the two lighting elements 71 are overlapped with each other almost completely. However, the lighting areas may be displaced with respect to each other. If the two lighting elements 71 face directions different from each other, the lighting areas can be displaced with respect to each other.

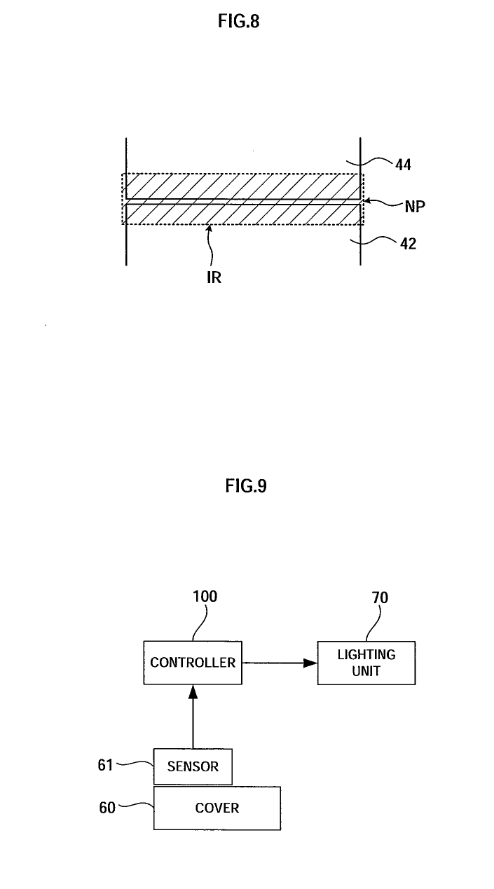

Subsequently, drive of the lighting unit 70 will be described with reference to FIG. 9. A controller 100 senses whether the cover 60 is opened or closed upon receipt of the output signals from the sensor 61. More specifically, if the cover 60 is in the closed position, the controller 100 receives an OFF signal from the sensor 61. In contrast, if the cover 60 is in the opened position, the controller 100 receives an ON signal from the sensor 61.

The controller 100 outputs a drive signal to the lighting unit 70 if it determines that the cover 60 is in the opened position on the basis of the output from the sensor 61. The lighting elements 71 emit lights when the lighting unit 70 receives the drive signal from the controller 100.

In this embodiment, the lighting unit 70 is driven when the cover 60 is opened. However, the lighting unit 70 can be continuously driven as long as a main power source of the image forming apparatus 1 is ON, for example. Reduction of the power consumption associated with the drive of the lighting unit 70 is achieved by driving the lighting unit 70 as in this embodiment.

In this embodiment, the fixing unit 40 is heated to high temperatures when fixing. In this embodiment, the user recognizes the fixing unit 40 as being red if the fixing unit 40 is irradiated with the red light. Then, the user can imagine that the fixing unit 40 is at a high temperature with the red light, so that an alert to the user is achieved.

In this embodiment, since alerting the user is achieved by using the illuminating light (red light), the effect of alerting the user is improved in comparison with the structure having only the warning label L1 stuck thereon.

With the structure having only the warning label L1 stuck thereon, the warning label L1 may be peeled off. If the warning label L1 is used, the position where the warning label L1 is to be stuck is narrowed down. In other words, in order to stick the warning label L1, a flat surface must be chosen. Therefore, the area where the warning label L1 is to be stuck may be deviated from the area where the user must really pay attention to.

In this embodiment, alerting the user is achieved irrespective of the shape where the warning should be reminded by using the illuminating light (red light). In other words, the user can be alerted by the irradiation of the illuminating light (red light) even though the corresponding area cannot be stuck with the warning label L1. For example, since the warning label L1 cannot be stuck on the nip of the fixing unit 40, alerting the user is achieved by reddening the nip using the red light.

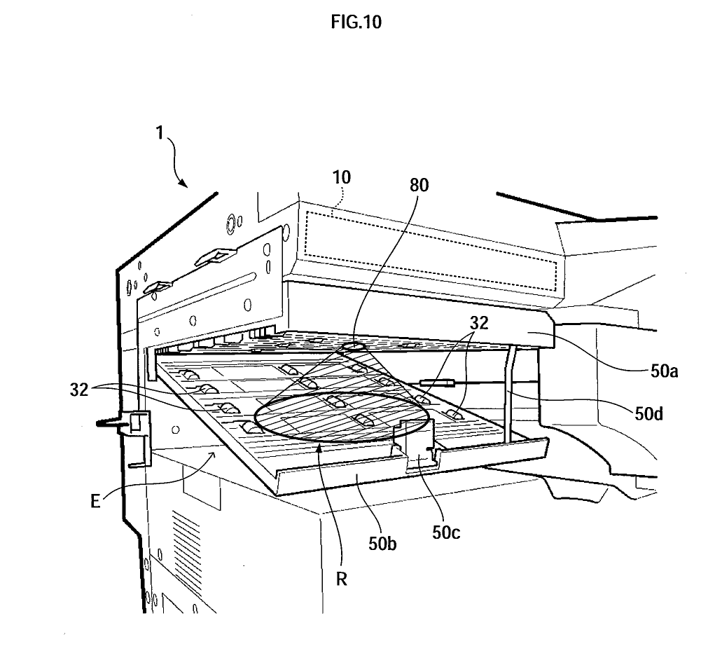

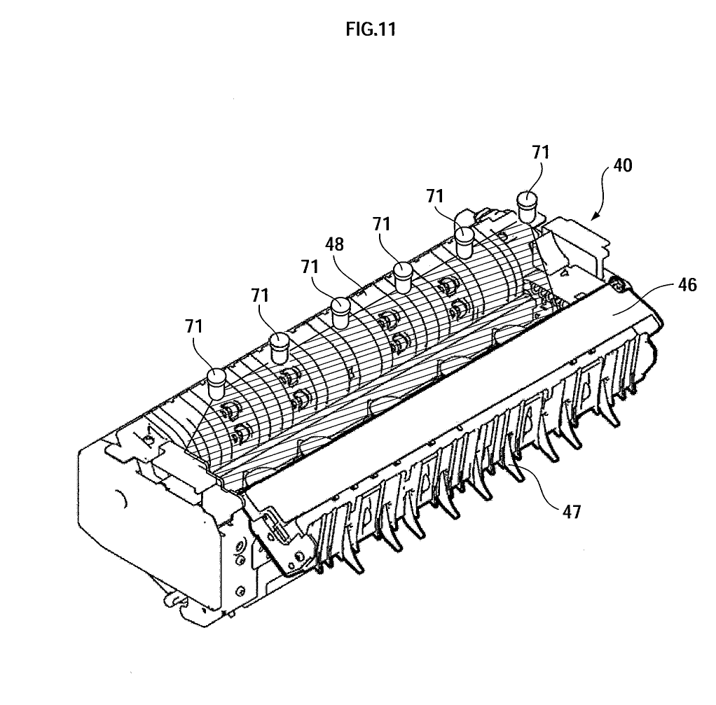

In contrast, as shown in FIG. 10, a lighting unit 80 configured to illuminate other portions in the interior of the image forming apparatus 1 can be used in addition to the lighting unit 70 described in this embodiment.

FIG. 10 shows a state in which the relay unit 50 is opened, and the finisher 51 described in FIG. 1 is omitted. The relay unit 50 includes two sub units 50a and 50b, and the sub units 50a and 50b include the rollers 32 configured to transport the paper. As shown in FIG. 10, the sub units 50a and 50b are moved apart from each other by operating a lever 50c. A belt 50d connects the sub units 50a and 50b.

As shown in FIG. 10, removal of the paper jammed in the relay unit 50 is enabled by separating the sub units 50a and 50b from each other. Here, the space E exists below the relay unit 50, and the space E serves as a space where the sub unit 50b moves downward.

The sub unit 50a includes the lighting unit 80, and the lighting unit 80 irradiates the illuminating light if the relay unit 50 is opened as shown in FIG. 10. Since the interior of the relay unit 50 is liable to be dark, using the illuminating light from the lighting unit 80 makes it possible to confirm the interior of the relay unit 50 easily. An area R in FIG. 10 is an area illuminated by the lighting unit 80. The lighting area R can be set as needed.

The lighting unit 80 irradiates illuminating light in colors other than red. For example, the color of the light irradiated by the lighting unit 80 may be white light. By using the illuminating lights in colors different from the red light as the lighting unit 80, the user can easily recognize the fact that the area illuminated by the lighting unit 70 is a heat-generating area.

A modification of this embodiment will be explained with reference to FIG. 11. In this embodiment, as shown in FIG. 3, the illuminating light is irradiated from obliquely above the fixing unit 40. However, as shown in FIG. 11, the illuminating light can be irradiated from above the fixing unit 40.

In FIG. 11, a plurality of the lighting elements 71 are provided above the fixing unit 40. The plurality of lighting elements 71 are arranged in the direction along the nip of the fixing unit 40. In other words, the plurality of lighting elements 71 are arranged in the direction along the rotating shafts of the rollers (the press roller 42 and the fixing roller 43) of the fixing unit 40. The number of the lighting elements 71 may be selected as needed.

In the example shown in FIG. 11, widening of the angle of irradiation of the illuminating light by the lighting elements 71 is achieved easily by shifting the lighting elements 71 away from the fixing unit 40. However, as the distances between the lighting elements 71 and the fixing unit 40 increase correspondingly, the image forming apparatus 1 is upsized. Downsizing of the image forming apparatus 1 is achieved easily by bringing the lighting elements 71 near the fixing unit 40. However, it narrows the angles of irradiation of the illuminating lights by the lighting elements 71. Therefore, with the arrangement of the plurality of lighting elements 71, the entire portion of the nip of the fixing unit 40 can be irradiated with the illuminating light as shown in FIG. 11.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus comprising:
a paper transporting unit configured to transport a paper;
an image forming unit configured to form an image on the paper;
a fixing unit configured to generate heat for fixing the image on the paper; and
a lighting unit configured to irradiate the fixing unit with red light.

2. The apparatus according to claim 1, further comprising:
a cover which constitutes a part of an exterior of the image forming apparatus and is configured to expose the fixing unit by being opened.

3. The apparatus according to claim 2, further comprising:
a sensor configured to output a signal according to whether the cover is opened or closed; and
a controller configured to determine whether the cover is opened or closed on the basis of the output from the sensor.

4. The apparatus according to claim 3, wherein
the controller drives the lighting unit when the cover is opened.

5. The apparatus according to claim 1, wherein
the lighting unit includes:
a lighting element configured to generate the red light; and
a substrate configured to support the lighting element.

6. The apparatus according to claim 5, wherein
the fixing unit includes:
a heating roller configured to provide heat to the paper; and
a press roller configured to press the paper against the heating roller; wherein
a plurality of the lighting elements are arranged in the direction along a rotating shaft of the heating roller.

7. The apparatus according to claim 6, wherein
the plurality of lighting elements are located above the fixing unit.

8. The apparatus according to claim 1, wherein
the fixing unit includes:
a heating roller configured to provide heat to the paper; and
a press roller configured to press the paper against the heating roller.

9. The apparatus according to claim 8, wherein
the lighting unit irradiates at least one of the heating roller and the press roller with the red light.

10. The apparatus according to claim 8, wherein
the lighting unit irradiates an area including a nip of the heating roller and the press roller with the red light.

11. The apparatus according to claim 8, wherein
the fixing unit includes a cover used for exposing a transporting passage of the paper for a jam removal operation of the paper.

12. The apparatus according to claim 11, wherein
the cover rotates about an axis parallel to a rotating shaft of the heat roller.

13. The apparatus according to claim 12, wherein
the cover includes a handle for rotating the cover.

14. The apparatus according to claim 1, further comprising:
a lighting unit configured to irradiate a portion different from the fixing unit with an illuminating light different from the red light.

15. The apparatus according to claim 1, further comprising:
a label stuck on the fixing unit and having information indicating that the fixing unit is hot written thereon.

16. A fixing apparatus comprising:
a heating roller configured to generate heat for fixing an image on a paper;
a press roller configured to press the paper against the heating roller; and
a lighting unit configured to irradiate at least one of the heating roller and the press roller with red light.

17. The apparatus according to claim 16, wherein
the lighting unit irradiates an area including a nip of the heating roller and the press roller with the red light.

18. The apparatus according to claim 16, wherein
the lighting unit includes:
a lighting element configured to irradiate the red light; and
a substrate configured to support the lighting element.

19. The apparatus according to claim 17, wherein
a plurality of the lighting elements are arranged in the direction of a rotating shaft of the heating roller.

20. An image forming method comprising:
transporting a paper;
forming an image on the paper;
heating the paper with a heating apparatus for fixing the image on the paper;
stopping transport of the paper if a jamming of the heated paper is sensed; and
irradiating the heating apparatus with red light when the transport of the paper is stopped and then a cover configured to cover the heating apparatus is opened.
